(19) United States
(12) Patent Application Publication
(10) Pub. No.: US 2015/0288667 A1
(43) Pub. Date: Oct. 8, 2015

(54) APPARATUS FOR SHARING A SESSION KEY BETWEEN DEVICES AND METHOD THEREOF

(71) Applicant: SAMSUNG ELECTRONICS CO., LTD., Suwon-si (KR)

(72) Inventor: Christopher Mark ALDER, Wokingham (GB)

(73) Assignee: SAMSUNG ELECTRONICS CO., LTD., Suwon-si (KR)

(21) Appl. No.: 14/539,621

(22) Filed: Nov. 12, 2014

(30) Foreign Application Priority Data
Apr. 8, 2014 (GB) GB1406315.0
May 29, 2014 (KR) 10-2014-0065114

(51) Int. Cl. H04L 29/06

(52) U.S. Cl. CPC H04L 63/061; H04L 63/083

(57) ABSTRACT

Methods and apparatuses for sharing a session key between first and second devices to pair the first and second devices. Information defining the session key is obtained by the first device, and output from the first device in accordance with a pairing protocol supported by the second device, in a form of an audio and/or visual signal. The second device can directly detect the audio and/or visual signal, or can receive the information in the form of user input.

### CROSS-REFERENCE TO RELATED APPLICATIONS

This application claims priority from Korean Patent Application No. 10-2014-0065114, filed on May 29, 2014, in the Korean Intellectual Property Office, and U.K. Patent Application No. GB1406315.0, filed on Apr. 8, 2014, in the United Kingdom Intellectual Property Office, the disclosures of which are incorporated herein by reference in their entireties.

### BACKGROUND

1. Field

An apparatus and a method consistent with exemplary embodiments relate to sharing a session key between devices, and more particularly to sharing information defining the session key in the form of an audio and/or visual signal.

2. Description of the Related Art

Many modern electronic devices have the ability to communicate with other devices. For example, in a home network environment, users are increasingly using second screen devices to supplement content viewed on a main screen, such as a digital television. Some applications require a secure connection, to prevent eavesdropping and tampering of the connection. The process of establishing a secure connection between devices can be referred to as ‘pairing’ the devices.

There are many existing mechanisms available to support a secure connection between devices. One of the most popular mechanisms is Hypertext Transfer Protocol Secure (HTTPs), which allows for secure communication between a client and a server. HTTPs makes use of certificates that are validated by known certificate authorities. However, this is a complex mechanism and not always the most appropriate way to enable secure pairing between a client and a server. In particular, one drawback of the HTTPs mechanism is the requirement to use an external certificate authority to prevent man in the middle attacks, which is not always suitable for lightweight client applications. However, embedding certificates on either device is potentially dangerous as certificates may be compromised. There is, therefore, a need for an improved pairing mechanism which can support a secure connection between devices, without using an external certificate authority.

### SUMMARY

An aspect of one or more exemplary embodiments provides for sharing a session key between apparatuses by sharing information defining the session key in the form of an audio and/or visual signal.

According to an aspect of an exemplary embodiment, a method of sharing a session key includes obtaining, by the first device, information defining the session key, and outputting, by the first device, in a form of an audio signal or a visual signal, the obtained information based on a pairing protocol supported by a second device to pair the first device with the second device.

The method of sharing a session key according to an exemplary embodiment may further include identifying, by the first device, the pairing protocol supported by the second device.

The method of identifying the paring protocol supported by the second device may further include transmitting to the second device information identifying a plurality of pairing protocols supported by the first device and receiving information identifying one of the plurality of pairing protocols supported by the first device as the pairing protocol supported by the second device.

The information defining the session key may include a shared secret.

The shared secret may be randomly generated by the first device.

The method of sharing a session key according to an exemplary embodiment may further include deriving, by the first device, the session key from the shared secret, using a Password Authenticated Key Exchange (PAKE) algorithm.

The method of sharing a session key according to an exemplary embodiment may further include receiving, from the second device, information identifying the PAKE algorithm as an algorithm for deriving the session key.

The shared secret may be a code, and the code may be displayed on a display of the first device.

The code is a Quick Response (QR) code.

According to an aspect of an exemplary embodiment, a method of sharing a session key between first and second devices to pair the first and second devices includes receiving, by the second device, the information defining the session key, obtaining, by the second device, the session key from the received information, and storing, by the second device, the session key.

Herein, the information defining the session key may include a shared secret, and obtaining the session key may include deriving the session key from the shared secret using a PAKE algorithm.

The method of sharing a session key according to an exemplary embodiment may include transmitting, from the second device to the first device, information identifying the PAKE algorithm as an algorithm for deriving the session key, prior to said receiving the information defining the session key.

The information defining the session key is user input received by the second device.

The information defining the session key may be received by the second device detecting the audio and/or visual signal.

The method of sharing a session key according to an exemplary embodiment may further include receiving, by the second device, information identifying a plurality of pairing protocols supported by the first device, selecting a pairing protocol supported by the second device, from among the plurality of pairing protocols supported by the first device provided in the received information, and transmitting information identifying the selected pairing protocol, from the second device to the first device.

The audio method may further include selecting an audio protocol, by the first device, for providing the information defining the session key based on the first device supporting both an audio protocol and a visual protocol.

The method of sharing a session key may further include generating a session identifier, storing the session identifier and the session key in a database arranged to store a plurality of session identifiers and a plurality of session keys, each one of the session identifiers being associated with a different one of the plurality of session keys, subsequently receiving, by the first device, a message including the session identifier and encrypted data, and determining one of the plurality of session keys which corresponds with the stored session identifier from the plurality of session identifiers for decrypting the received encrypted data.

The method may further include the first device being paired with a third device and the obtaining the information defining the session key may include obtaining information defining a different session key to a session key used by the first device and the third device for decrypting and encrypting data between the first device and the third device.

The method may further include the first device being paired with a third device and the obtaining the information defining the session key may further include retrieving a stored shared secret used when pairing the first device with the third device, as the information defining the session key in the session between the first device and the second device.

The method of sharing a session key according to an exemplary embodiment may further include performing, by the first device, Universal Plug and Play (UPnP) discovery to request a description file with respect to the second device, and receiving, by the first device, the description file. The description file may include metadata indicating one or more pairing protocols supported by the second device.

The method of sharing a session key according to an exemplary embodiment may further include storing the information defining the session key in a non-volatile memory of the first device, and storing a session identifier in a volatile memory of the first device.

The first device or the second device may be a digital television.

A non-transitory computer-readable storage medium may be arranged to store a computer program for performing the method according to claim 1.

An apparatus for sharing a session key with an external apparatus according to an exemplary embodiment includes a key information generator configured to obtain information defining a session key, and an outputter configured to output the generated information, in a form of an audio and/or a visual signal based on a pairing protocol supported by the external apparatus.

The apparatus for sharing a session key with an external apparatus according to an exemplary embodiment may further include a pairer configured to identify the pairing protocol supported by the external apparatus.

The pairer may further be configured to transmit, to the external apparatus, information identifying a plurality of pairing protocols supported by the apparatus, and may further be configured to receive information identifying one of the plurality of pairing protocols supported by the apparatus as the pairing protocol supported by the external apparatus.

The information defining the session key may include a shared secret.

The key information generator may be configured to obtain the shared secret by randomly generating the shared secret.

The apparatus for sharing a session key with an external apparatus according to an exemplary embodiment may further include a PAKE algorithm executor configured to derive the session key from the shared secret using a PAKE algorithm.

The apparatus for sharing a session key with an external apparatus according to an exemplary embodiment may further include a network interface configured to receive, from the external apparatus, information identifying the PAKE algorithm as an algorithm to derive the session key.

The outputter may be a display configured to display the shared secret in a form of a code.

The code may be a QR code.

According to another aspect of an exemplary embodiment, an apparatus for sharing a session key with an external apparatus may be provided, which includes a receiver configured to receive, from the external apparatus, information defining the session key. The information may be output by the external apparatus in a form of a visual signal and/or audio signal. The apparatus may further include a session key generator configured to generate the session key from the received information, and a memory configured to store the session key.

The information defining the session key may include a shared secret, and the apparatus may further include a PAKE algorithm executor configured to derive the session key from the shared secret using a PAKE algorithm.

The apparatus may include a network interface configured to communicate with the external apparatus, and configured to transmit information identifying the PAKE algorithm for said generating of the session key by the external apparatus, prior to receiving the information defining the session key.

The apparatus may further include a user interface configured to receive the information defining the session key as user input.

The receiver may further be configured to receive the information defining the session key by detecting the audio and/or visual signal output by the external apparatus via a speaker and/or a display.

The apparatus may further include a network interface configured to communicate with the external apparatus, and configured to receive information identifying a plurality of pairing protocols supported by the external apparatus, and a pairer configured to select a pairing protocol supported by the apparatus, from among the plurality of pairing protocols supported by the external apparatus, the network interface being further configured to transmit information identifying the pairing protocol selected by the pairer to the external apparatus.

In response to the information identifying the plurality of pairing mechanisms indicating that an audio protocol and a visual protocol are supported by the external apparatus, the pairer is configured to select the audio protocol.

The apparatus may further include a session manager configured to generate a session identifier and a memory configured to store the session identifier and the session key in a database arranged to store a plurality of session identifiers and a plurality of session keys, each one of the session identifiers being associated with a different one of the plurality of session keys. In response to a receiving a message including the session identifier and encrypted data, the session manager is further configured to determine one of the plurality of session keys for decrypting the encrypted data, by querying the database to obtain the session key associated with the session identifier included in the received message.

The apparatus may be paired with a third device and the key information generator may further be configured to obtain information defining a different session key from a session key used by the apparatus and the third device.

The apparatus may be paired with a third device and the apparatus may be configured to retrieve a stored shared secret used when pairing the apparatus with the third device, as the information defining the session key between the first device and the second device.

The apparatus may further include an UPnP discovery executor configured to perform UPnP discovery to request a description file for the external apparatus and configured to receive the description file. The description file may include metadata indicating one or more pairing protocols supported by the external apparatus.

The apparatus may further include a non-volatile memory configured to store the information defining the session key and a volatile memory configured to store a session identifier.

The apparatus may be a digital television.

### BRIEF DESCRIPTION OF THE DRAWINGS

The above and/or other aspects will be more apparent by describing certain exemplary embodiments with reference to the accompanying drawings, in which:

FIG. 1. is a flowchart illustrating a method of sharing a session key between first and second devices according to an exemplary embodiment;

FIG. 2 is a flow diagram illustrating a method of sharing a session key between first and second devices according to another exemplary embodiment;

FIG. 3 is a flow diagram illustrating a method of managing sessions, according to an exemplary embodiment;

FIG. 4 is a view illustrating a shared secret being displayed as a quick response code according to an exemplary embodiment;

FIG. 5 is a view illustrating a shared secret being displayed as a numerical code according to an exemplary embodiment; and

FIG. 6 is a block diagram illustrating a system having a digital television and a mobile device according to an exemplary embodiment.

### DETAILED DESCRIPTION OF THE EXEMPLARY EMBODIMENTS

Hereinafter, exemplary embodiments will be described in greater detail with reference to the accompanying drawings. If it seems that a detailed explanation regarding a related art or a configuration in an exemplary embodiment obscures a substance of an inventive concept with an unnecessary detail, the detailed explanation is omitted.

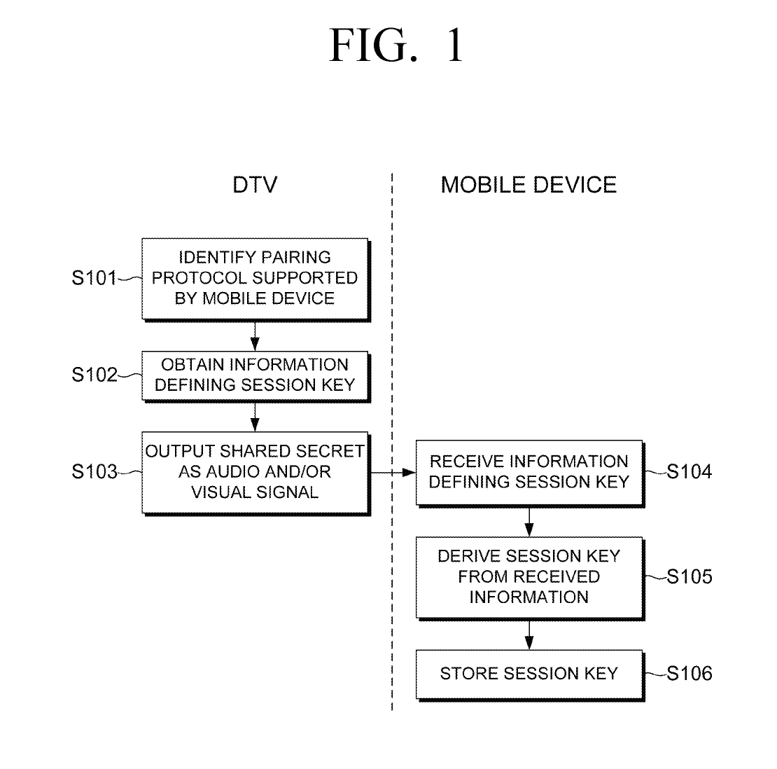

FIG. 1 is a flow diagram illustrating a method of sharing a session key between two devices so as to pair these devices according to an exemplary embodiment. In an exemplary embodiment, a mobile device, such as a smart phone or a tablet computer, is paired with a digital television (DTV) which is an external apparatus. However, different types of device can be paired in other exemplary embodiments.

In an exemplary embodiment, ‘pairing’ two devices may be construed as indicating that the devices exchange a session key which can be used to encrypt and decrypt data sent between the two devices. Once the devices are paired, each device can use the session key to encrypt data, and then send the encrypted data to the other device in the payload of an HTTP session, for example. The paired receiving device can then decrypt the encrypted data using the same session key.

To share the session key in an exemplary embodiment, in operation S101, the DTV begins by identifying a pairing protocol supported by a mobile device which is an external apparatus. The pairing protocol defines a specific technique to be used when sharing the session key between the devices. In an exemplary embodiment, the pairing protocol indicates that a shared secret for deriving the session key is to be displayed in the form of a quick-response (QR) code.

In an exemplary embodiment, the DTV and mobile device both include a network interface such as a network interface card to enable the devices to communicate over any suitable wired or wireless network connection, for example WiFi, Bluetooth or Zigbee. This allows the devices to negotiate a suitable pairing protocol that is compatible with both devices. However, in other exemplary embodiments, both devices can be pre-programmed to use a default pairing protocol, in which case the operation of identifying a pairing protocol can be omitted since both devices will automatically use the same pairing protocol.

After identifying a pairing protocol that is compatible with both the DTV and the mobile device, in operation S102, the DTV obtains information defining the session key. In an exemplary embodiment, the DTV randomly generates the information defining the session key in operation S102, but in other exemplary embodiments, the information could be retrieved from a stored list.

As described above, in an exemplary embodiment, the information defining the session key is a shared secret from which the session key can be derived. For example, in operation S102, the DTV can first obtain a session key and then derive the shared secret from the session key, or alternatively, the DTV can directly generate the shared secret.

Although in an exemplary embodiment, the information defining the session key is obtained after identifying the pairing protocol to be used, in another exemplary embodiment, the order of operations S101 and S102 can be reversed, so that the information defining the session key is obtained before the pairing protocol has been identified. As a further alternative exemplary embodiment, operations S101 and S102 could be performed simultaneously by different components within the DTV.

Next, in operation S103, the DTV outputs the information defining the session key in accordance with the identified pairing protocol, in the form of an audio and/or visual signal. By using an audio and/or visual signal, the information defining the session key can only be received by another device within a line of sight to the DTV, and/or within the audible range of the DTV. The possibility of a man-in-the-middle attack by a third party at a different location, for example in a neighboring building, is therefore avoided without having to use an external certificate authority.

As described above, in an exemplary embodiment, the pairing protocol indicates that a shared secret is to be displayed in the form of a QR code. Therefore, in operation S103, the DTV encodes the shared secret in a QR code, and displays the QR code on a display screen.

Although a QR code is used in an exemplary embodiment, in other exemplary embodiments, the shared secret can be encoded differently. Furthermore, exemplary embodiments are not limited to use of a shared secret, and in other exemplary embodiments, the information defining the session key can take various forms. In one exemplary embodiment, the information defining the session key can be a direct textual representation of the session key, for example as a string of characters such as a 4-digit PIN.

Next, in operation S104, the mobile device receives the information defining the session key. Here, various approaches are possible depending on the form in which the DTV outputs the information in operation S103. Since a QR code is used in an exemplary embodiment, in operation S104, a QR code reader application on the mobile device is used to scan the displayed QR code to obtain the shared secret encoded in the QR code. That is, the mobile device directly detects the visual signal output by the DTV.

In another exemplary embodiment, the shared secret can be encoded in an audio signal and output using a speaker, in which case, the mobile device can directly detect the audio signal using a microphone. In yet another exemplary embodiment, a string of characters representing either the shared secret or the session key itself could be displayed in operation S103, and received in operation S104 by a user typing the characters into the second device using a user interface, or by capturing an image of the DTV screen and extracting the string of characters using an optical character recognition (OCR) algorithm. Although characters are provided by way of an example, it is possible to use an image or an icon in yet another exemplary embodiment as the shared secret.

Next, in operation 5105 the mobile device derives the session key from the shared secret using a suitable algorithm, for example, a Password Authenticated Key Exchange (PAKE) algorithm such as Simple Password Exponential Key Exchange (SPEKE), Password Authenticated Key Exchange by Juggling (J-PAKE), or Encrypted Key Exchange (EKE). As with the pairing protocol, both devices can negotiate which algorithm to use, or can be pre-programmed to use the same algorithm by default. Then, in operation S106, the mobile device stores the session key. At this point, the DTV and the mobile device are now paired, and can communicate securely using the shared session key.

Although in the method shown in FIG. 1, the DTV is responsible for generating the session key, in another exemplary embodiment, the device roles can be reversed, such that the mobile device generates a session key and shares the session key with the DTV. Also, the present disclosure is not limited to pairing a DTV and a mobile device, and in other exemplary embodiments, any suitable devices can be paired.

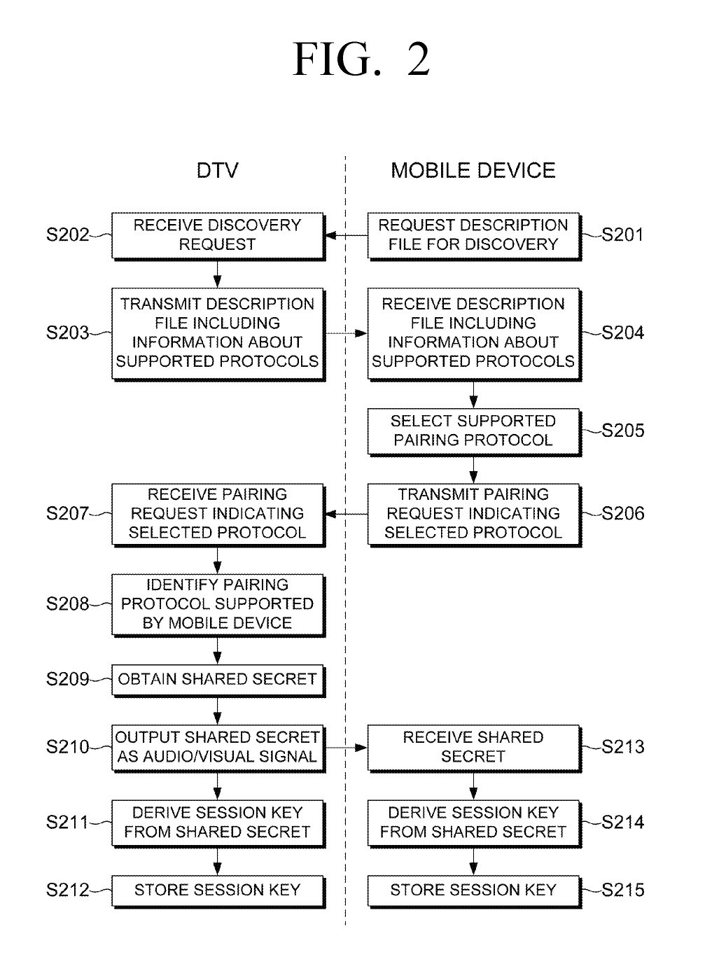

Referring now to FIG. 2, is a flow diagram illustrating a method of sharing a session key between first and second devices according to yet another exemplary embodiment. In the method shown in FIG. 2, Universal Plug and Play (UPnP) discovery is used to identify and select a suitable pairing protocol that is supported by both the devices.

First, in operation S201, the mobile device performs Universal Plug and Play UPnP discovery to request a description file for the DTV, and the discovery request is received by the DTV in operation S202.

In response to the discovery request, the DTV generates a description file including metadata indicating one or more pairing protocols supported by the DTV, and in operation S203, transmits the description file to the mobile device. In an exemplary embodiment, an Extensible Markup Language (XML) format is used for the description file, as follows:

<?xml version=“1.0”?>

<root ...>
<xs:element name=“pakevalues” type=“valuelist”>
<xs:element name=“pairingtypes ” type=“valuelist”>
<device SupportPairing=“true”>
< pakevalues > j-pake speke eke </ pakevalues >
< pairingtypes > pin qr </ pairingtypes >
</device>
</root ...>

In an exemplary embodiment, the element (date field) device includes the attribute SupportPairing which indicates whether or not the DTV supports an audio-visual pairing protocol according an exemplary embodiment. The attribute is set to “TRUE” if an audio-visual protocol is supported, and “FALSE” if an audio-visual protocol is not supported. The element (data field) pakevalues contains a list of PAKE algorithms supported by the DTV, which can be used to derive a session key from a shared secret. In an exemplary embodiment, the DTV supports the use of J-PAKE, SPEKE and EKE algorithms. The element (date field) pairingtypes contains a list of the different types of audio-visual pairing protocols that are supported by the DTV. In an exemplary embodiment, QR-based and PIN-based visual pairing protocols are supported.

In operation S204, the mobile device receives the description file from the DTV. Then, in operation S205, the mobile device selects an algorithm and pairing protocol that are supported by the mobile device, amongst the algorithms and pairing protocols identified in the description file.

In some exemplary embodiments, in response to the description file indicating that an audio protocol and a visual protocol are supported by the first device, a device can be arranged to automatically select the audio pairing protocol in preference to the visual pairing protocol. An audio method may be less intrusive when a user is currently watching a television program, for example, and so may be preferred to a visual method. In yet another exemplary embodiment, the shared secret may be displayed in a portion of a screen such as a text line or a small widget window so as not to interrupt the user who is watching a television program.

Next, in operation S206, the mobile device transmits information identifying the selected algorithm and the pairing protocol to the DTV, in the form of a pairing request, and the DTV receives the pairing request in operation S207. Then, in operation S208, the DTV can identify the algorithm and pairing protocol signaled in the pairing request as being supported by the mobile device.

After identifying the suitable pairing protocol in operation S208, a session key is shared with the mobile device in operations S209, S210, S213, S214 and S215, in accordance with the identified pairing protocol. Operations S209, S210, S213, S214 and S215, according to an exemplary embodiment, somewhat respectively correspond to operations S102 to S106 of FIG. 1. Accordingly, to avoid redundancy, a detailed description is omitted. In operation S214, the mobile device derives the session key by using the PAKE algorithm that was signaled to the DTV in the pairing request.

Also, after obtaining the shared secret in operation S209, in operation S211, the DTV derives the shared secret using the PAKE algorithm that was signaled in the pairing request. This ensures that the DTV and the mobile device both derive the same session key from the shared secret. Then, in operation S212, the DTV stores the derived session key.

In the exemplary embodiment illustrated in FIG. 2, the same device which performs UPnP discovery also selects the pairing protocol to be used. However, present disclosure is not limited to this approach. In another exemplary embodiment, a device can include information about its own capabilities in the UPnP discovery request, for example, by including one or both of the elements pakevalues and pairingtypes, as described above. The device receiving the UPnP discovery request can then use this information to select an algorithm and/or pairing protocol that is compatible with both devices, and signal the selected algorithm/protocol to the other device in the UPnP description file. Furthermore, in some exemplary embodiments, a combination of these two approaches can be used, with one device selecting the PAKE algorithm and the other device selecting the pairing protocol.

By using a method, as shown in FIG. 2, to negotiate a suitable algorithm and/or pairing protocol between devices, exemplary embodiments can enable devices of different capabilities to be paired with one another. For example, a DTV can be paired with a smartphone device which includes a camera by using a QR-based pairing protocol, and the same DTV can be paired with a tablet computer without a camera by using a user-input PIN-based pairing protocol. These are provided by way of an example and are not limiting to the present disclosure.

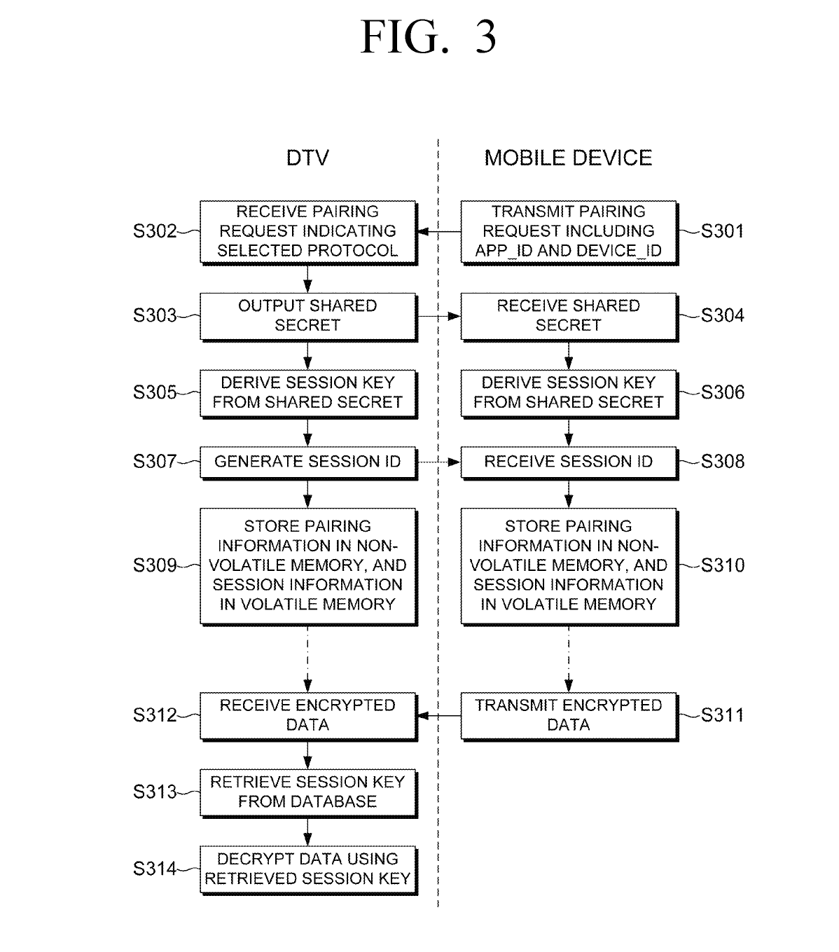

Referring now to FIG. 3, is a flow diagram illustrating a method of managing sessions according to an exemplary embodiment. In an exemplary embodiment, one of the devices, in the present example the mobile device, transmits a pairing request to the other device in operation S301. The pairing request is received by the DTV in operation S302. Operations S301 and S302 somewhat respectively correspond to operations S206 and S207 of FIG. 2, and it will be appreciated that various aspects of the methods of FIGS. 2 and 3 can be combined in exemplary embodiments as required or needed.

In more detail, in operation S301, the mobile device (client) requests the start of a secure session (by way an example, refer to operation S206) by connecting to a defined uniform resource locator (URL), which in the present example takes the form:

http://server_ip/ws/pairing

where server_ip is the Internet Protocol (IP) address of the server to which the client is trying to connect, in this case, the DTV. The mobile device signals which algorithm and pairing protocol to use by adding these as parameters to the connection URL as follows:

http://server_ip/ws/pairing ?step=0&app_id=xyz&device_id=xyz&pakevalues=eke&pairingtype=qr

In an exemplary embodiment, the pake value “EKE” is signaled, and the pairing type (protocol) “QR” is signaled. In addition, as shown in the above exemplary embodiment, the pairing request includes an application identifier (app_id) for the application which is initiating the connection, and the device identifier (device_id) for the mobile device.

By using an application identifier, multiple connections for different applications can be supported simultaneously between the same two devices.

In operations S303 to S306, a session key can be obtained and shared between the DTV and the mobile device using any of the above-described exemplary methods, in accordance with the algorithm and protocol signaled in the pairing request. For the sake of brevity, a detailed description will not be repeated here.

In some exemplary embodiments, when the DTV is already paired with another device, in operation S303, the DTV can be arranged to obtain a different session key to a session key already in use by the DTV and the other device. This maintains the security of the connection between the DTV and other device, by preventing the mobile device from joining the session already in progress. Alternatively, in other exemplary embodiments, the DTV can be arranged to obtain the shared secret in operation S303 by retrieving a stored shared secret which was previously used when pairing the DTV with the other device, in order to allow the mobile device to join the existing session and communicate with both the DTV and the other device with the same session key.

Then, in operation 5307 and S308, a session ID is generated by the DTV and transmitted to the mobile device. In other exemplary embodiments, operations 5307 and S308 could be performed at any other stage. For example, a session ID could be generated and transmitted before outputting the shared secret. In operations 5309 and 5310, each device stores the pairing information in a non-volatile memory, and stores the session information in a volatile memory.

Once the session information has been stored, the devices can communicate securely. For example, in operation 5311, the mobile device can generate a message by encrypting data using the current session key, and sending the encrypted data in the payload of a message which also includes the session identifier. On receipt of the message, in operation S312, the DTV can then retrieve the session key corresponding to the received session identifier from the volatile memory in operation S313. Then, in operation S314, the DTV can use the retrieved session key to decrypt the data.

Any of the above-described exemplary methods, shown in FIGS. 1, 2 and 3, can be implemented by software instructions in one or more computer programs which, when executed by one or more processors in a device, causes the device to perform the corresponding method operations for that device.

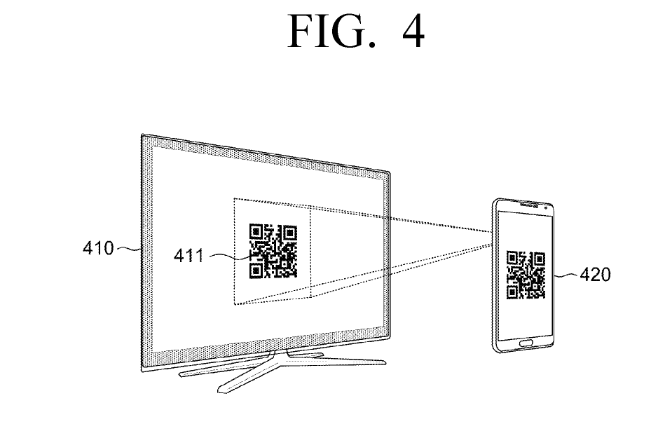

FIG. 4 is a view illustrating a shared secret being displayed as a quick response code according to an exemplary embodiment. As shown in FIG. 4, a DTV 410 displays the shared secret in the form of a QR code 411, which can be scanned using a QR reader application on a mobile device 420. In some exemplary embodiments, the session key itself can be directly embedded in the QR code without using a shared secret. In such exemplary embodiments, because a shared secret is not used, the PAKE algorithms, described above with reference to FIGS. 2 and 3, are not required.

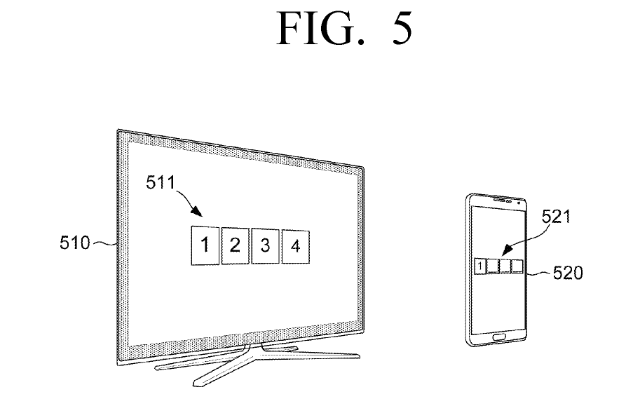

FIG. 5 is view illustrating a shared secret being displayed as a numerical code according to an exemplary embodiment. In an exemplary embodiment depicted in FIG. 5, the numerical code is a 4-digit pin code. As shown in FIG. 5, the DTV 510 displays the PIN code 511, and a user inputs the displayed code into the mobile device 520 using a user interface screen 521.

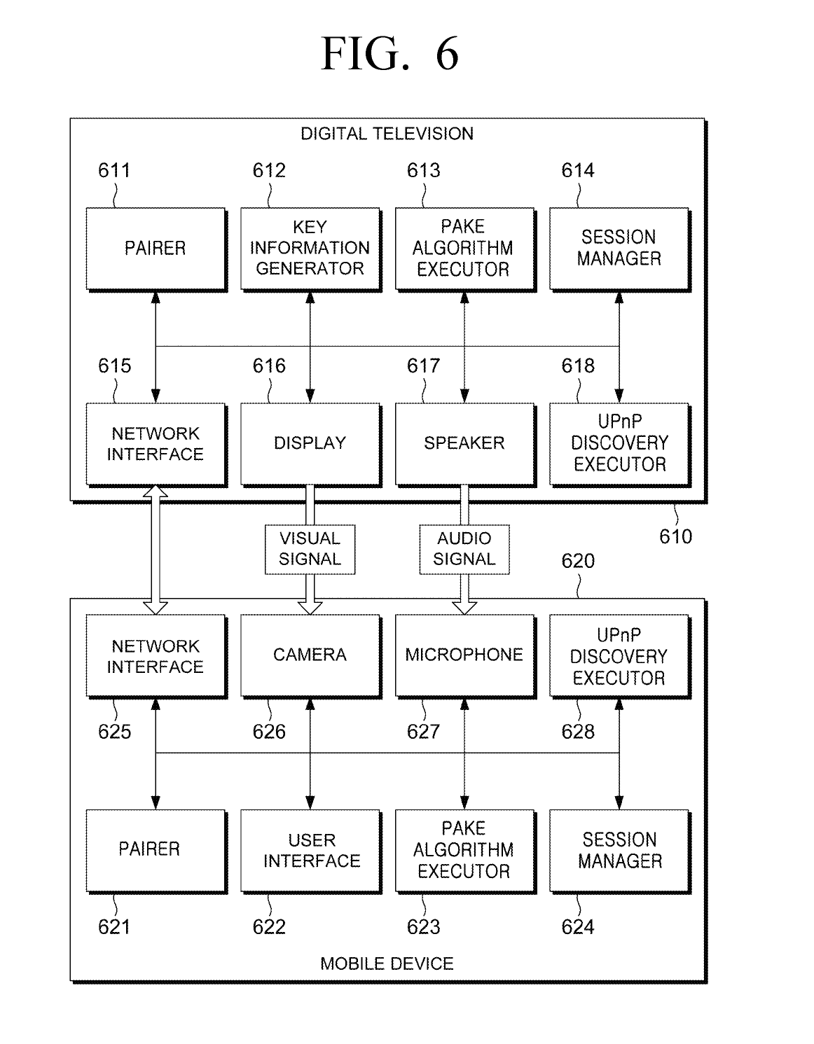

FIG. 6 is a block diagram illustrating a system having a digital television and a mobile device according to an exemplary embodiment. Certain elements/components/circuitry depicted in FIG. 6 can be implemented in software or in hardware, or a combination of both software and hardware.

As shown in FIG. 6, in an exemplary embodiment, the DTV 610 includes a pairer 611, a key information generator 612, a PAKE algorithm executor 613, a session manager 614, a network interface 615, a display 616, a speaker 617 and an UPnP discovery executor 618. The mobile device 620 includes a pairer 621, a user interface 622, a PAKE algorithm executor 623, a session manager 624, a network interface 625, a camera 626, a microphone 627, and UPnP discovery executor 628.

According to an exemplary embodiment, as shown in FIG. 6, the pairer 611 and 621 are responsible for pairing the two devices. For example, the pairer 611 is configured to identify the pairing protocol supported by the mobile device 620 and the pairer 621 is configured to identify the pairing protocol supported by the digital television 610. In an exemplary embodiment, these pairing components 611 and 621 may work together to identify the pairing protocol that can be used to establish communication between the mobile device 620 and the digital television 610. For example, the pairer 611 transmits information identifying a plurality of pairing protocols supported by the digital television 610, to the mobile device 620, and receives information identifying one of the plurality of pairing protocols supported by the mobile device 620 as the supported pairing protocol.

The key information generator 612 is configured to generate a shared secret such as the ones shown in FIGS. 4 and 5. That is, the key information generator 612 is arranged to obtain information defining a session key. For example, the key information generator is arranged to obtain the shared secret by randomly generating the shared secret.

The PAKE algorithm executor 613 and the PAKE algorithm executor 623 are configured to apply the PAKE algorithm to the shared secret to derive a session key. For example, the PAKE algorithm 613 is arranged to derive the session key from the shared secret using a PAKE algorithm such as the exemplary PAKE algorithms described above.

In an exemplary embodiment, the display 616 and speaker 617 of the digital television 610 are configured to output the information defining the session key in accordance with a pairing protocol supported by the mobile device, in a form of a visual signal and/or an audio signal e.g., a shared secret as described above in some of exemplary embodiments. The network interfaces 615 and 625 are configured to facilitate communication between the digital television 610 and the mobile device 620. For example, the network interface 615 is configured to receive information identifying the PAKE algorithm to be used. The user interface 622 is configured to receive the information defining the session key e.g., a shared secret as user input. The session managers 614 and 624 are configured to generate a session identifier and store the session identifier and the session key in a database arranged to store a plurality of session identifiers and a plurality of session keys, each one of the session identifiers being associated with a different one of the plurality of session keys. In an exemplary embodiment, multiple sessions may be initiated between the mobile device 620 and the digital television 610 for various different applications. The UPnP discovery executors 618 and 628 are arranged to perform UPnP discovery to request a description file for the external apparatus and receive the description file, which includes metadata indicating one or more pairing protocols supported by the external apparatus. That is, in an exemplary embodiment, each of the discovery executors 618 and 628 may generate an UPnP request and/or an UPnP response. Additionally, each of the discovery executors may generate an UPnP request that includes a description file about the supported protocols of its device or it may generate an UPnP response with the description file about the supported protocols for its device.

The exemplary elements/components/circuitry illustrated in FIG. 6 provide the DTV 610 and the mobile device 620 with the necessary functionality to execute any of the exemplary methods described above with reference to FIGS. 1, 2 and 3. It will be appreciated that certain elements may be omitted in certain exemplary embodiments, when the functionality provided by those elements is not required. For example, when a session key is directly embedded in a QR code, PAKE algorithms are not required and accordingly the PAKE algorithm units can be omitted.

While certain exemplary embodiments have been described herein with reference to the illustrative drawings, it will be understood that many variations and modifications will be possible without departing from the scope and spirit of an inventive concept as defined in the accompanying claims and their equivalents. One of ordinary skill in the art would readily appreciate that all exemplary embodiments and modifications conceived from the meaning and scope of the claims and their equivalents are included in the scope of the present disclosure.

What is claimed is:

1. A method of sharing a session key comprising:
obtaining, by a first device, information defining a session key; and
outputting, by the first device, in a form of an audio or a visual signal, the obtained information based on a pairing protocol supported by a second device to pair the first device with the second device.

2. The method of claim 1, further comprising:
identifying, by the first device, the pairing protocol supported by the second device.

3. The method of claim 2, wherein the identifying comprises:
transmitting to the second device, information identifying a plurality of pairing protocols supported by the first device; and
receiving, by the first device, information identifying one of the plurality of pairing protocols supported by the first device as the pairing protocol supported by the second device.

4. The method of claim 1, wherein the information defining the session key comprises a shared secret.

5. The method of claim 4, wherein the shared secret is randomly generated by the first device.

6. The method of claim 4, further comprising:
deriving, by the first device, the session key from the shared secret using a Password Authenticated Key Exchange (PAKE) algorithm.

7. The method of claim 6, further comprising:
receiving, from the second device, information identifying the PAKE algorithm as an algorithm for deriving the session key.

8. The method of claim 4, wherein the shared secret is a code displayed on a display of the first device.

9. The method of claim 8, wherein the code is a Quick Response (QR) code.

10. A method of sharing a session key comprising:
receiving, by a second device, information defining the session key obtained from a first device;
obtaining, by the second device, the session key from the received information to pair the first device with the second device; and
storing, by the second device, the session key.

11. The method of claim 10, wherein the information defining the session key comprises a shared secret, and
wherein the obtaining the session key comprises deriving the session key from the shared secret using a Password Authenticated Key Exchange (PAKE) algorithm.

12. The method of claim 11, further comprising:
transmitting, from the second device to the first device, information identifying the PAKE algorithm as an algorithm for deriving the session key, prior to said receiving the information defining the session key.

13. The method of claim 10, wherein the information defining the session key is user input received by the second device.

14. The method of claim 10, wherein said receiving the information defining the session key comprises detecting, by the second device, audio and/or visual signal output by the first device.

15. The method of claim 10, further comprising:
receiving, by the second device, information identifying a plurality of pairing protocols supported by the first device;
selecting a pairing protocol supported by the second device, from among the plurality of pairing protocols supported by the first device provided in the received information; and
transmitting information identifying the selected pairing protocol, from the second device to the first device.

16. The method of claim 15, further comprising selecting an audio protocol, by the first device, for providing the information defining the session key based on the first device supporting both an audio protocol and a visual protocol.

17. The method of claim 1, further comprising:
generating a session identifier;
storing the session identifier and the session key in a database arranged to store a plurality of session identifiers and a plurality of session keys, each one of the session identifiers being associated with a different one of the plurality of session keys;
receiving, by the first device a message including the stored session identifier and encrypted data; and
determining one of the stored plurality of session keys which corresponds with the stored session identifier from the plurality of session identifiers for decrypting the received encrypted data.

18. The method of claim 1, wherein the first device is paired with a third device, and
wherein said obtaining the information defining the session key comprises obtaining information defining a different session key to a session key used by the first device and the third device for decrypting and encrypting data between the first device and the third device.

19. The method of claim 1, wherein the first device is paired with a third device, and
wherein said obtaining the information defining the session key comprises retrieving a stored shared secret used when pairing the first device with the third device, as the information defining the session key in a session between the first device and the second device.

20. The method of claim 1, further comprising:
performing, by the first device, Universal Plug and Play (UPnP) discovery to request a description file with respect to the second device; and
receiving, by the first device, the description file,
wherein the description file comprises metadata indicating at least one pairing protocol supported by the second device.

21. The method of claim 1, further comprising:
storing the information defining the session key in a non-volatile memory of the first device; and
storing a session identifier in a volatile memory of the first device.

22. The method of claim 1, wherein at least one of the first device and the second device is a digital television.

23. A non-transitory computer-readable storage medium arranged to store a computer program for performing the method according to claim 1.

24. An apparatus for sharing a session key with an external apparatus, the apparatus comprising:
a key information generator configured to obtain information defining a session key; and
an outputter configured to output the generated information, in a form of at least one of an audio signal and a visual signal based on a pairing protocol supported by the external apparatus.

25. The apparatus of claim 24, further comprising:
a pairer configured to identify the pairing protocol supported by the external apparatus.

26. The apparatus of claim 25, wherein the pairer is further configured to transmit, to the external apparatus, information identifying a plurality of pairing protocols supported by the apparatus, and is further configured to receive information identifying one of the plurality of pairing protocols supported by the apparatus as the pairing protocol supported by the external apparatus.

27. The apparatus of claim 24, wherein the information defining the session key comprises a shared secret.

28. The apparatus of claim 27, wherein the key information generator is further configured to obtain the shared secret by randomly generating the shared secret.

29. The apparatus of claim 27, further comprising:
a Password Authenticated Key Exchange (PAKE) algorithm executor configured to derive the session key from the shared secret using a PAKE algorithm.

30. The apparatus of claim 29, wherein the apparatus further comprises a network interface configured to receive, from the external apparatus, information identifying the PAKE algorithm as an algorithm to derive the session key.

31. The apparatus of claim 27, wherein the outputter is a display configured to display the shared secret in a form of a code.

32. The apparatus of claim 31, wherein the code is a QR code.

33. An apparatus for sharing a session key with an external apparatus the apparatus comprises:
a receiver configured to receive, from the external apparatus, information defining a session key, wherein the information is output by the external apparatus in a form of at least one of a visual signal and an audio signal;
a session key generator configured to generate the session key from the received information; and
a memory configured to store the session key.

34. The apparatus of claim 33, wherein the information defining the session key comprises a shared secret, and the apparatus further comprises:
a Password Authenticated Key Exchange (PAKE) algorithm executor configured to derive the session key from the shared secret using a PAKE algorithm.

35. The apparatus of claim 34, further comprising: a network interface configured to communicate with the external apparatus, and configured to transmit information identifying the PAKE algorithm for said generating of the session key by the external apparatus, prior to receiving the information defining the session key.

36. The apparatus of claim 33, wherein the apparatus further comprises:
a user interface configured to receive the information defining the session key as user input.

37. The apparatus of claim 33, wherein the receiver is further configured to receive the information defining the session key by detecting said at least one of the audio and the visual signal output by the external apparatus via at least one of a display and a speaker.

38. The apparatus of claim 33, wherein the receiver comprises a network interface configured to communicate with the external apparatus, and configured to receive information identifying a plurality of pairing protocols supported by the external apparatus; and
wherein the apparatus further comprises a pairer configured to select a pairing protocol supported by the apparatus, from among the plurality of pairing protocols supported by the external apparatus,
wherein the network interface is further configured to transmit information identifying the pairing protocol selected by the pairer to the external apparatus.

39. The apparatus of claim 38, wherein, in response to the information identifying the plurality of pairing mechanisms indicating that an audio protocol and a visual protocol are supported by the external apparatus, the pairer is configured to select the audio protocol.

40. The apparatus of claim 24, wherein the apparatus further comprises:
a session manager configured to generate a session identifier and a memory configured to store the session identifier and the session key in a database which is configured to store a plurality of session identifiers and a plurality of session keys, each one of the session identifiers being associated with a different one of the plurality of session keys,
wherein in response to receiving a message including the session identifier and encrypted data, the session manager is further configured to determine one of the plurality of session keys for decrypting the encrypted data, by querying the database to obtain the session key associated with the session identifier included in the received message.

41. The apparatus of claim 24, wherein the apparatus is paired with a third device and wherein the key information generator is configured to obtain information defining a different session key from a session key used by the apparatus and the third device.

42. The apparatus of claim 24, wherein the apparatus is paired with a third device and wherein the apparatus is configured to retrieve a stored shared secret used when pairing the apparatus with the third device, as the information defining the session key between the first device and the second device.

43. The apparatus of claim 24, wherein the apparatus further comprises:
an UPnP discovery executor configured to perform UPnP discovery to request a description file for the external apparatus and configured to receive the description file,
wherein the description file comprises metadata indicating at least one pairing protocol supported by the external apparatus.

44. The apparatus of claim 24, further comprises:
a non-volatile memory configured to store the information defining the session key; and
a volatile memory configured to store a session identifier.

45. The apparatus of claim 24, wherein the apparatus is a digital television.

46. The method of claim 1, wherein said outputting comprises outputting in the form of an audio signal the obtained information via a speaker and wherein the output audio signal is automatically detected and recognized by the second device to obtain the information.

47. The method of claim 1, wherein said outputting comprises displaying a visual signal on a display of the first device and wherein the displayed information is input by a user into the second device to generate the session key.

48. The method of claim 10, wherein the information defining the session key is output in a form of both an audio signal and a visual signal, which is received by the second device.

49. The method of claim 48, wherein the audio signal is output by a speaker of the first device and is automatically detected and recognized by the second device, which is in a vicinity of the first device and wherein the visual signal is displayed by the display of the first device and is manually input by a user into the second device.

50. The method of claim 48, wherein:
the audio signal is output by a speaker of the first device and is automatically detected and recognized by the second device to obtain a first portion of a shared secret, which is in a vicinity of the first device,
the visual signal is displayed by the display of the first device and is captured by a camera of the second device and is recognized by the second device to obtain a second portion of a shared secret, and
combining the obtained first portion of the shared secret and the second portion of the shared secret to generate the session key based on the combined portions.
